(19) United States
(12) Patent Application Publication
(10) Pub. No.: US 2011/0296483 A1
(43) Pub. Date: Dec. 1, 2011

(54) DIGITAL BROADCAST RECEIVER

(76) Inventor: Hidemitsu Shimamoto, Tokyo (JP)

(21) Appl. No.: 13/089,346

(22) Filed: Apr. 19, 2011

(30) Foreign Application Priority Data
Jun. 1, 2010 (JP) 2010-126135

(51) Int. Cl. H04N 7/173

(52) U.S. Cl. 725/110

(57) ABSTRACT

A digital broadcast receiver having a conditional access card exchanges information related to broadcast programs with an information server via the Internet. When the conditional access card generates a tuning command in preparation for an exchange of such related information, a controller in the digital broadcast receiver sends the conditional access card a pseudo confirmation response so that the conditional access card can operate as if the related information were to be transmitted and received by conventional out-of-band signaling. Out-of-band signaling circuits, if present in the digital receiver, are powered off when the related information can be transmitted and received via the Internet.

### BACKGROUND OF THE INVENTION

1. Field of the Invention

The present invention relates to a digital broadcast receiver, more particularly to a digital broadcast receiver that supports the OpenCable standard.

2. Description of the Related Art

Terrestrial digital broadcasting has recently begun in many countries, and there is a trend toward a complete transition to digital broadcasting, including the cessation of analog broadcasting. Cable broadcasting is also becoming digital. The United States and Korea have adopted a cable broadcasting system referred to as OpenCable. The required specifications for a receiver based on this system are disclosed in non-patent document 1.

In the OpenCable system, a conditional access card referred to as a cable card is defined that performs decoding for conditional access and also performs processing of out-of-band (OOB) signals. OOB signals use a specially provided channel, different from the audio and video channels. OOB signals are used when conditional access information, an electric program guide (EPG), and other information are transmitted and received between the cable headend and the receiver. An exemplary OpenCable compatible receiver using a cable card is shown in patent document 1.

There are two methods of transmitting OOB signals: one method uses QPSK modulation; the other method is a DOCSIS set-top gateway (DSG) method, based on the data-over-cable service interface specification (DOCSIS), which uses QAM modulation. The former method is disclosed in non-patent documents 2, 3 and the latter method in non-patent document 4. The two methods are not used simultaneously; one method or the other is used, depending on the cable television station.

Meanwhile, thanks to the recent popularization of ADSL and optical fibers, always-on broadband connections to the Internet are becoming more common. By use of the broadband connection environment, digital broadcast receivers are also being connected to the Internet and commercial services that enable video content to be reproduced by streaming are starting to be deployed.

3. Prior Art Documents

Patent document 1: Japanese Translation of PCT Patent Application, Japanese Publication No. 2008-510352.

Non-patent document 1: OpenCable Host Device 2.1 Core Functional Requirements; OC-SP-HOST2.1-CFR-109-090904, Cable Television Laboratories, Inc.

Non-patent document 2: ANSI/SCTE 55-1 2009, Digital Broadband Delivery System: Out of Band. Transport Part 1: Mode A.

Non-patent document 3: ANSI/SCTE 55-2 2008, Digital Broadband Delivery System: Out Of Band Transport Part 2: Mode B.

Non-patent document 4: DOCSIS Set-top Gateway (DSG) Interface Specification, CM-SP-DSG-114-090529, May 29, 2009, Cable Television Laboratories, Inc.

A digital broadcast receiver that supports the OpenCable standard must include a transmitting and receiving circuit having a tuner, modulator, and demodulator dedicated to OOB signals, as well as a cable modem having a tuner, modulator, and demodulator dedicated to DOCSIS scheme. This causes problems of high cost and high power consumption due to large circuit size.

### SUMMARY OF THE INVENTION

An object of the present invention is to reduce the cost of a digital broadcast receiver without impairing its convenience to the user.

According a first aspect of the present invention, there is provided a digital broadcast receiver to which a conditional access card can be connected, and which includes:
a transmitting and receiving unit configured to transmit and receive data related to a broadcast program to and from an information server via the Internet, said data related to the broadcast program including conditional access data;
a buffer in which the transmitting and receiving unit temporarily stores the data related to the broadcast program transmitted from the information server; and
a control unit for causing the data stored in the buffer to be supplied at a predetermined rate to the conditional access card.

The transmitting and receiving unit transmits data output from the conditional access card to the information server via the Internet.

Before transmission and reception of the data related to the broadcast program, the control unit replies to a tuning command from the conditional access card with a pseudo confirmation response indicating the success of tuning.

According a second aspect of the present invention, there is provided a digital broadcast receiver to which a conditional access card can be connected, and which includes:
a transmitting and receiving unit configured to transmit and receive data related to a broadcast program to and from an information server via the Internet, said data related to the broadcast program including conditional access data;
a buffer in which the transmitting and receiving unit temporarily stores the data related to the broadcast program transmitted from the information server;
a control unit for causing the data stored in the buffer to be supplied at a predetermined rate to the conditional access card;
a frontend for transmitting and receiving the data related to the broadcast program to and from a cable television station via a cable; and
a local power supply for the frontend.

When the transmitting and receiving unit can receive the data related to the broadcast program via the Internet, the control unit turns off the local power supply and receives the broadcast program by using the data related to the broadcast program received by the transmitting and receiving unit.

According to the first aspect of the invention, an internal transmitting and receiving circuit including a tuner, modulator, and demodulator dedicated to OOB signals, and an internal cable modem including a tuner, modulator, and demodulator dedicated to DOCSIS scheme are not required. Resulting effects are that the circuit size and manufacturing cost can be reduced.

According to the second aspect of the invention, it is possible to transmit and receive data related to the broadcast program, with the same content as is conventionally transmitted as OOB data, even when network communication is unavailable, without consuming power unnecessarily.

### BRIEF DESCRIPTION OF THE DRAWINGS

In the attached drawings:

FIG. 1 is a block diagram showing a digital broadcast receiver in a first embodiment of the invention;

FIG. 2 illustrates the digital broadcast receiver in FIG. 1 together with streaming servers and an information server at a cable television station;

FIG. 3 illustrates an upstream packet used in the invention;

FIG. 4 illustrates a downstream packet used in the invention;

FIG. 5 illustrates the operation of the CPU in FIG. 1;

FIG. 6 is a block diagram showing a digital broadcast receiver in a second embodiment of the invention; and

FIG. 7 illustrates the digital broadcast receiver in FIG. 6 together with streaming servers and an information server at a cable television station.

### DETAILED DESCRIPTION OF THE INVENTION

### First Embodiment

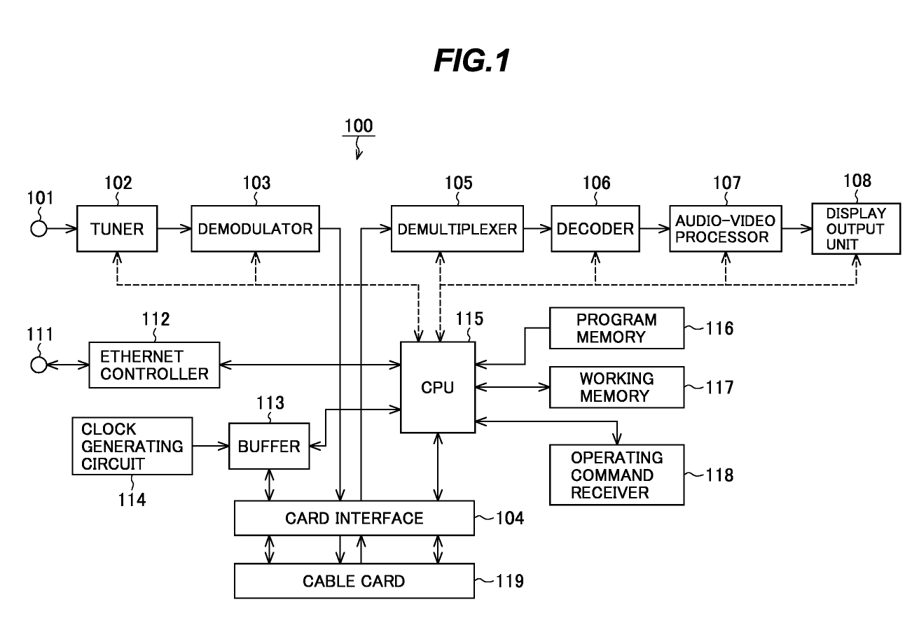

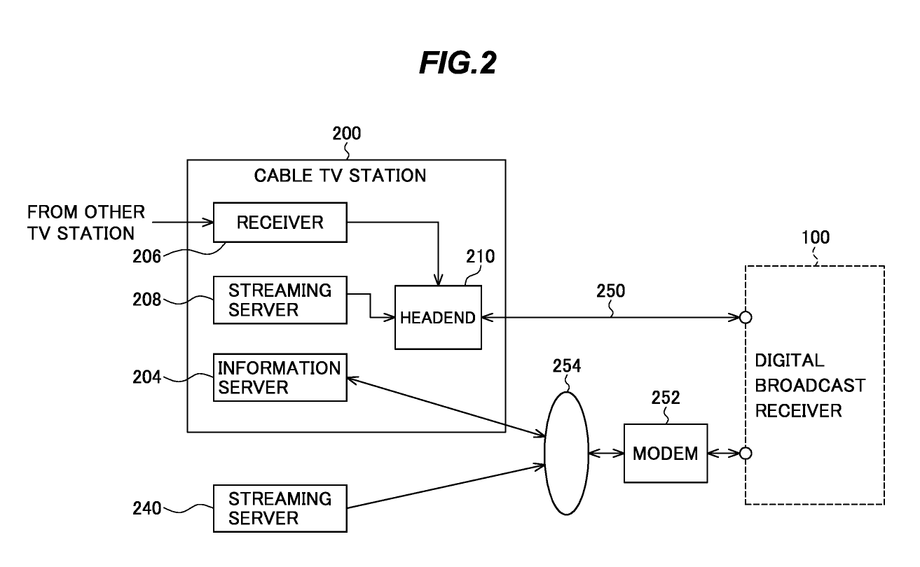

FIG. 1 is a block diagram showing the structure of a digital broadcast receiver 100 in a first embodiment of the invention. FIG. 2 schematically illustrates the digital broadcast receiver 100 together with relevant equipment at a cable television station 200 and a streaming server 240.

The digital broadcast receiver 100 shown in FIGS. 1 and 2 is installed on subscriber or user premises and is connected to receive broadcast programs that are transmitted from the cable television (TV) station 200 and distributed via a cable 250. The digital broadcast receiver 100 is also connected via the Internet 254 and by a modem 252 on the subscriber's premises to an information server 204 in the cable television station 200, and to the streaming server 240.

The cable television station 200 transmits the audio and video data of broadcast programs and has, in addition to the information server 204, a receiver 206, a streaming server 208, and a headend 210.

The receiver 206 receives and outputs digital broadcast programs transmitted from other television stations (not shown). The streaming server 208 stores video content and outputs the content as broadcast programs.

The headend 210 mixes the data streams of broadcast programs output from the receiver 206 and/or streaming server 208 and sends the resulting mixture to the cable 250, through which the mixture is distributed to subscribers.

The information server 204 transmits and receives data other than broadcast program data, including, for example, data similar to the data transmitted and received by so-called OOB servers via cables in conventional structures. The data preferably conform to the OOB standard and will be referred to herein as OOB data.

Streaming server 240 distributes audio and video data streams via the Internet 254. Streaming server 240 may be disposed within the cable television station 200 or may be disposed in a different place. When disposed within the cable television station 200, streaming server 240 may be the same server as streaming server 208.

Audio and video broadcast program data are transmitted and received between the cable television station 200 and the digital broadcast receiver 100 via the cable 250. Also, information accompanying or related to the transmission of the audio and video broadcast program data is transmitted and received between the cable television station 200 and the digital broadcast receiver 100 via the cable 250.

This information includes control information for conditional access (including a conditional access decoding or descrambling key and unique device information), an electronic program guide, applications for video on demand (VOD), and other applications. Such information will be referred to below as ‘related information’. The related information can be classified according to its transmission direction into downstream data, that is, forward data channel (FDC) information, and upstream data, that is, reverse data channel (RDC) information.

The digital broadcast receiver 100 can also receive audio and video data from the streaming server 240 via the Internet 254, and data (related information) accompanying or relating to the transmission of these audio and video data can be transmitted and received between the information server 204 and the digital broadcast receiver 100 via the Internet 254.

The digital broadcast receiver 100 has an input terminal 101 for a digital cable signal, a tuner 102 for tuning to desired audio and video channels, a demodulator 103 for demodulating the cable signal, a card interface 104, a demultiplexer (DEMUX) 105 for separating a decoded signal into audio and video signals, a decoder 106 for decoding the separated audio and video signals, an audio-video processor 107 for adjusting the picture quality and sound, a display output unit 108 for performing video display and sound output, an Ethernet terminal 111 (Ethernet is a registered trademark) connected to a network, an Ethernet controller 112 used as a communication interface, a buffer 113 for temporarily storing the related information, a clock generating circuit 114, a CPU 115, a program memory 116, a working memory 117, and an operating command receiver 118.

Among the above elements, the tuner 102 and demodulator 103 constitute a receiving unit; the demultiplexer 105, decoder 106, audio-video processor 107, and display output unit 108 constitute a data processing unit.

The operating command receiver 118 receives signals from an operating command input unit (not shown) and sends the signals to the CPU 115. The operating command input unit includes, for example, a key input device or a remote control with which the user enters operating commands.

The digital broadcast receiver 100 is provided with a slot (not shown) for insertion of a cable card 119 used as a conditional access card. When inserted in the slot, the cable card 119 is connected to the card interface 104 and performs decoding or descrambling for conditional access to the audio and video data input from the demodulator 103 as described later. The cable card 119 also has a copy prevention function for protecting content.

The CPU 115 operates according to programs stored in the program memory 116. The CPU 115 executes, for example, cable card control software similar to conventional cable card software, which is stored in the program memory 116. The CPU 115 controls the Ethernet terminal 111, Ethernet controller 112, buffer 113, and clock generating circuit 114. The CPU 115 also controls the tuner 102, demodulator 103, demultiplexer 105, decoder 106, audio-video processor 107, and display output unit 108 by sending control signals via signal lines indicated by dashed lines.

The Ethernet terminal 111 is connected via the modem 252 to the Internet 254, and to the information server 204 and the streaming server 240. The Ethernet controller 112 controls communication performed via the Ethernet terminal 111.

The audio and video signals constituting a broadcast program transmitted from the headend 210 in the cable television station 200 are transmitted using the frequency band from, for example, 54 MHz to 864 MHz. QAM-64 or QAM-256 modulated audio and video signals are transmitted on assigned 6-MHz channels within this band. The digital broadcast receiver 100 receives the distributed audio and video signals at the input terminal 101.

The tuner 102 tunes to specific desired audio and video channels that are specified by the user by operating, for example, the key input device or remote control (both not shown). The demodulator 103 demodulates the output from the tuner 102 and outputs a bitstream. The bitstream is scrambled because of conditional access, and therefore is input to the cable card 119 to be descrambled.

After being descrambled in the cable card 119, the bitstream is separated into a video stream and an audio stream in the demultiplexer 105, and these streams are decoded by the decoder 106. The audio-video processor 107 then adjusts the picture quality and sound and the display output unit 108 performs video display and sound output. These operations are also controlled by the CPU 115.

IP packets on the Internet 254, which are delivered from the streaming server 240 and the information server 204, are sent via the Ethernet controller 112 to the CPU 115.

The CPU 115 executes access software pre-installed and stored in the program memory 116, connects via the Internet 254 to the streaming server 240, performs authentication operations, and takes delivery of audio and video streams.

The user datagram protocol (UDP) transport protocol is employed for the audio and video stream data. The data are divided up and placed in the payloads of UDP packets as shown in FIG. 4, and IP packets including the UDP packets are delivered to the CPU 115.

The CPU 115 uses the working memory 117 to store and reconstruct the stream data and outputs the result to the demultiplexer 105. The demultiplexer 105, decoder 106, audio-video processor 107, and display output unit 108 operate as in the case of the cable signals described above, the display output unit 108 performing video display and sound output as in the cable signal case.

The information server 204 is installed and connected to the Internet 254 in the same manner as the streaming server 240.

A conventional information server installed in a cable television station transmits OOB data via the cable 250, using a physical layer based on QPSK modulation and a data link layer including a MAC sub-layer. The information server 204 assumed in the present invention, however, uses the physical layer and data link layer of the Internet 254 to transmit OOB data.

Like the stream data from the streaming server 240, the OOB data from the information server 204 use the UDP transport protocol of the Internet 254, and are divided up and placed in UDP packets as shown in FIG. 4. IP packets including the UDP packets are delivered to the CPU 115.

When OOB data are transmitted from the information server 204 in the cable television station 200 to the digital broadcast receiver 100 via the Internet 254 (the downstream case), the CPU 115 uses the working memory 117 to store the stream data, extracts the OOB data from the UDP packets, and supplies the extracted OOB data to the buffer 113.

The clock generating circuit 114 generates an OOB clock to be sent to the cable card 119 and supplies the generated OOB clock to the buffer 113.

The clock generated by the clock generating circuit 114 is used to synchronize data transmission. This clock is set to the same frequency as the clock used in the conventional art in which OOB signals are QPSK modulated and transmitted via the cable 250. In the conventional art, a clock generating circuit is provided in the QPSK modulating circuit or QPSK demodulating circuit. When the OOB data are received via the Internet 254, however, no QPSK modulating and demodulating circuits are required, so the clock generating circuit 114 is provided alone in place of these circuits. The clock generating circuit 114 in this description need not include an oscillator; it may generate a clock having a desired frequency in response to a signal received from an external oscillator.

The buffer 113 supplies the received OOB data to the cable card 119 on the basis of the clock generated by the clock generating circuit 114. Accordingly, the cable card 119 can operate as in the conventional case in which QPSK modulated OOB data are transmitted via the cable 250.

When OOB data are transmitted from the digital broadcast receiver 100 to the information server 204 via the Internet 254 (upstream case), a clock generated by the clock generating circuit 114 is supplied to the cable card 119 and the data generated in the cable card 119 are received by the buffer 113. The clock used in this case is also set to the conventional clock frequency.

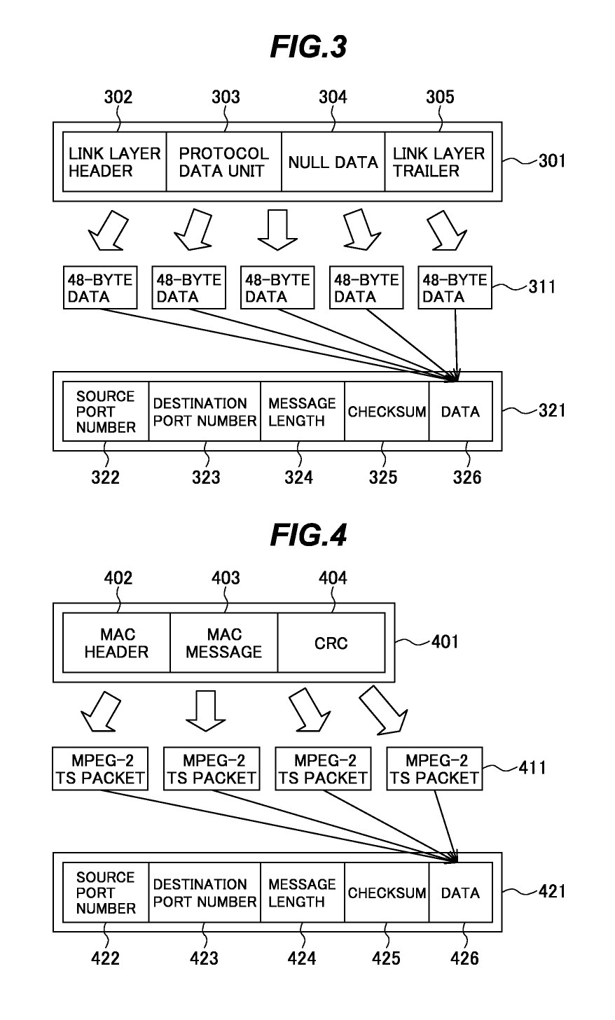

Data from the cable card 119 are stored in the buffer 113, transferred to the working memory 117 on command from the CPU 115, and formed into UDP packets as shown in FIG. 3. IP packets including these UDP packets are transmitted through the Ethernet controller 112 and the Internet 254 to the information server 204 to be processed.

The upstream packet structure will now be described with reference to FIG. 3.

A data link layer protocol data unit 301 generated in the cable card 119 includes a link layer header 302, a protocol data unit 303, null data 304 as padding data, and a link layer trailer 305.

The protocol data unit 301 is divided according to the OOB standard into groups of 48-byte data 311 and placed as data in a UDP packet 321.

The UDP packet 321 has a data block 326 in which the groups of 48-byte data 311 are placed, and also has a source port number 322 giving the port number used by the digital broadcast receiver 100, a destination port number 323 giving the port number used by the information server 204, a message length field 324, and a checksum 325.

Next, the downstream packet structure will be described with reference to FIG. 4. The MAC sub-layer protocol data unit 401 includes a header 402, a message 403, and a cyclic redundancy check (CRC) code 404.

The protocol data unit 401 is temporarily reconfigured according to the OOB standard as a private stream 411 in an MPEG-2 transport stream (TS), which is placed as data in a UDP packet 421.

The UDP packet 421 has a data block 426 in which the private stream 411 is placed, a source port number 422 giving the port number used by the information server 204, a destination port number 423 giving the port number used by the digital broadcast receiver 100, a message length field 424, and a checksum 425.

As noted above, conventional cable card control software is stored in the program memory 116 and executed by the CPU 115.

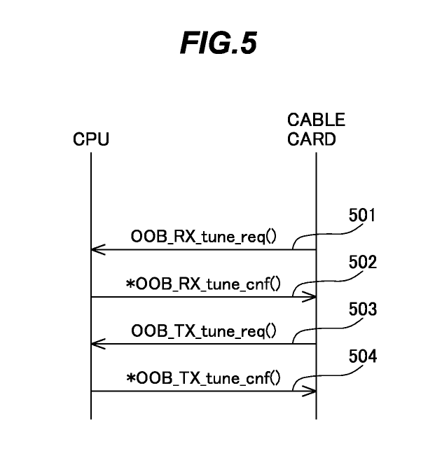

FIG. 5 illustrates part of the process carried out at the start of an exchange of OOB data between the information server 204 and the digital broadcast receiver, showing commands and responses exchanged between the CPU 115 and cable card 119. When a transmission frequency tuning command 501 is sent from the cable card 119 in response to a sign-on request from the information server 204, the CPU 115 returns only a pseudo confirmation response 502 with a value of ‘0’, indicating that tuning succeeded.

In the conventional structure, when the tuner that receives OOB signals via the cable succeeds in tuning, the CPU 115 returns a confirmation response with a value of ‘0’ to the cable card 119, indicating success. When delivery is received via the Internet 254, however, such tuning is not performed, so the pseudo confirmation response is returned without actual tuning confirmation. This makes it possible for the cable card 119 to receive and process signals similar to the ones received when OOB data are transmitted and received via the cable 250.

Likewise, when a receiving frequency tuning command 503 is sent from the information server 204, the CPU 115 returns only a confirmation response 504 with the value ‘0’, indicating that tuning succeeded. By returning a pseudo response and having the information server transmit the necessary signals in this way, it is possible to continue communication even when a conventional cable card (a cable card assuming data transmission via the cable 250) is used.

When the Internet connection with the information server 204 is broken, that is, when the Ethernet controller 112 cannot confirm the connection with the information server 204, the CPU 115 notifies the cable card 119 and descrambling is canceled, that is, decoding for conditional access is not performed. Broadcast content can be protected in this way.

Various applications in the application layer of the Internet can be used, including, for example, the secure shell (SSH) technology frequently used in secure communication (communication using encryption technology) and the hypertext markup language (HTML). UDP was used above as the transport protocol, but similar effects can also be obtained with the transmission control protocol (TCP) or other technology.

### Second Embodiment

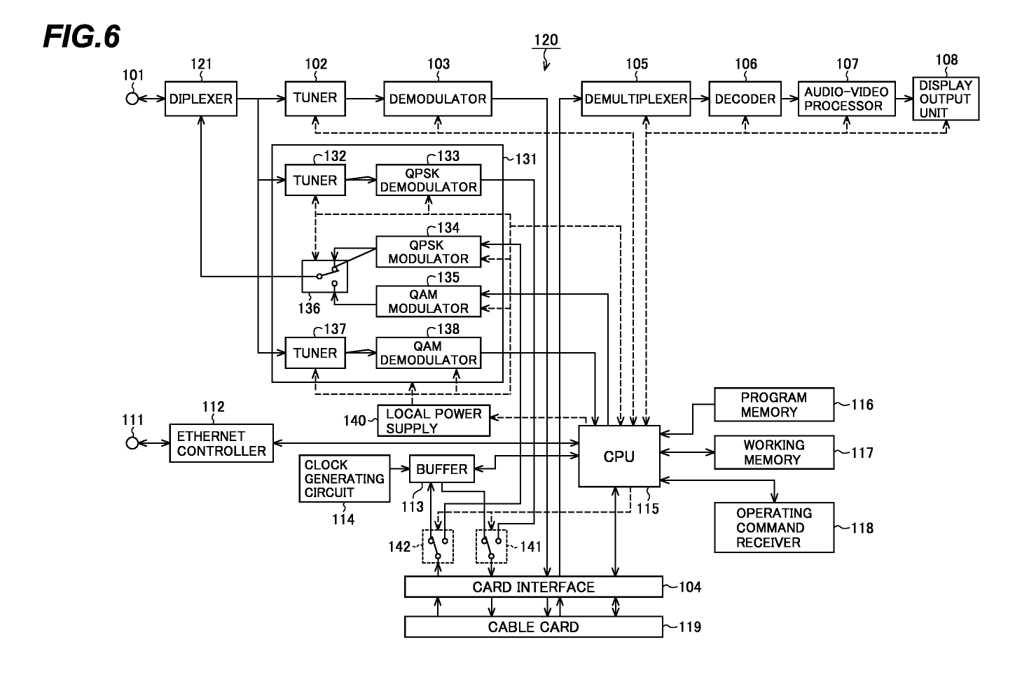

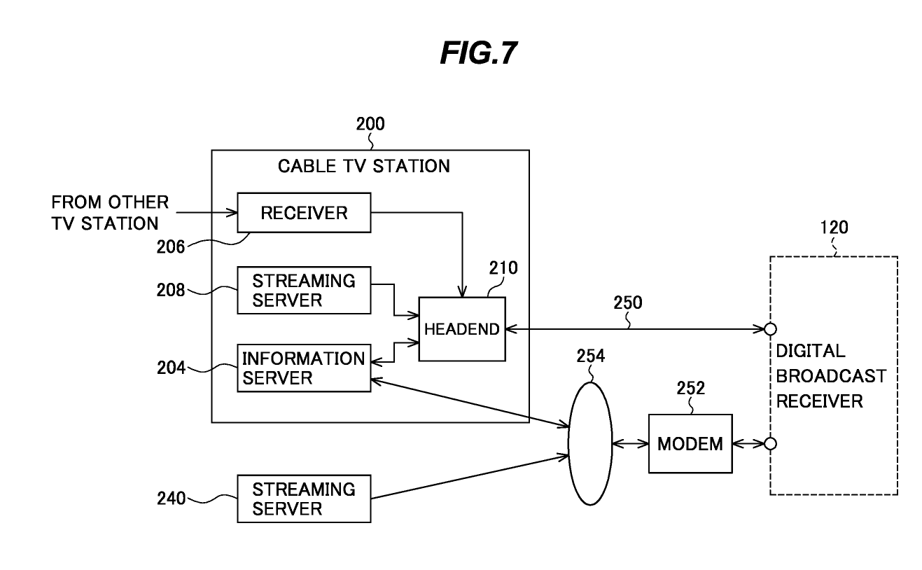

FIG. 6 is a block diagram showing the structure of a digital broadcast receiver 120 in a second embodiment of the invention. FIG. 7 schematically illustrates the digital broadcast receiver 120 together with relevant equipment at the cable television station 200 and the streaming server 240.

The digital broadcast receiver 120 shown in FIG. 6 is generally similar to the digital broadcast receiver 100 in FIG. 1, with like numbers indicating like elements. Digital broadcast receiver 120 differs from digital broadcast receiver 100 in that digital broadcast receiver 120 has, in addition to the elements shown in FIG. 1, a diplexer 121, an OOB frontend 131, a local power supply 140, and selectors 141, 142, and in that the input terminal 101 in FIG. 1 becomes an input-output terminal 101 in FIG. 6.

The information server 204 shown in FIG. 7 is connected not only to the Internet 254 as in the first embodiment, but also to the headend 210, resulting in a structure in which related information can be transmitted and received either as OOB data via the Internet 254, or as OOB signals via the headend 210 and the cable 250.

The headend 210 mixes the data streams of broadcast programs output from the receiver 206 and streaming server 208 with related information output from the information server 204 and, like the headend 210 in FIG. 2, outputs the resulting mixture. The frequency band used for transmitting the related information from the information server 204 differs from the frequency band used for transmitting audio and video data.

The headend 210 also receives data from the digital broadcast receiver 120 as described later and supplies the data to the information server 204. The information server 204 corresponds, in the conventional structure, to an OOB server that transmits and receives data to and from a subscriber's digital broadcast receiver as OOB signals.

The OOB frontend 131 in the digital broadcast receiver 120 has a tuner 132 for tuning to QPSK modulated OOB signals, a QPSK demodulator 133 for demodulating QPSK signals, a QPSK modulator 134 for performing QPSK modulation, a QAM modulator 135 for performing QAM modulation, a selector 136 for selecting and outputting either the signal from the QPSK modulator 134 or the signal from the QAM modulator 135, a tuner 137 for tuning to QAM modulated DSG signals, and a demodulator 138 for demodulating QAM signals.

The local power supply 140 is a dedicated power supply provided for the OOB frontend 131 and is turned on or off under control of the CPU 115.

Selector 141 selects either the demodulated OOB signal data from the QPSK demodulator 133 or the OOB data from the buffer 113 and supplies the selected data to the cable card 119 via the card interface 104; selector 142 supplies a data signal output from the cable card 119 via the card interface 104 to either the QPSK modulator 134 or the buffer 113.

The selectors 141, 142 operate in coordination: when selector 141 selects the output of the QPSK demodulator 133, selector 142 supplies a data signal to the QPSK modulator 134; when selector 141 selects the output of the buffer 113, selector 142 supplies a data signal to the buffer 113.

An RF signal from the headend 210, including audio and video signals and OOB signals, is input to the input terminal 101.

The diplexer 121 connected to the input terminal 101 separates downstream signals from upstream signals.

The downstream signals are supplied to the tuners 102, 132, 137. The signal supplied to tuner 102 is processed in the same way as in the first embodiment.

Tuner 132 tunes to a QPSK modulated OOB signal, which is demodulated by the QPSK demodulator 133 and then supplied to selector 141. The OOB signal data output from the buffer 113 are also supplied to selector 141, which supplies either the output from the QPSK demodulator 133 or the output from the buffer 113 to the cable card 119.

The CPU 115 connects with the information server 204 when the digital broadcast receiver 100 is started up or when the cable card 119 is inserted.

If the information server 204 is accessible on the network, making the OOB signal data available via the network, the CPU 115 has selector 141 select the output of the buffer 113. Otherwise, the CPU 115 has selector 141 select the output of the QPSK demodulator 133.

Tuner 137 tunes to an OOB signal modulated by the DSG method, which is demodulated by the QAM demodulator 138, supplied to the CPU 115, and then supplied to the cable card 119 via an extended channel defined in the control space of the CPU 115 and cable card 119.

In the upstream case, signal data from the cable card 119 are supplied to selector 142, which supplies the signal data under control of the CPU 115 to either the QPSK modulator 134 or the buffer 113: to the QPSK modulator 134 in the QPSK case, and to the buffer 113 in the case of network delivery.

When the OOB signal data are supplied to the QPSK modulator 134, the OOB signal data are QPSK modulated in the QPSK modulator 134 and supplied to selector 136.

The operations performed when the OOB signal data are supplied to the buffer 113 are the same as in the first embodiment.

That is, the data from the cable card 119 are stored in the buffer 113, transferred to the working memory 117 on command from the CPU 115, and formed into UDP packets. IP packets including the UDP packets are transmitted through the Ethernet controller 112 and the Internet 254 to the information server 204 to be processed.

OOB signal data to be modulated by the DSG scheme are supplied from the cable card 119 to the CPU 115 via the extended channel and then supplied by the CPU 115 to the QAM modulator 135.

The outputs from the QPSK modulator 134 and QAM modulator 135 are supplied to selector 136.

Selector 136, operating under control of the CPU 115, selects the output of the QPSK modulator 134 when the headend 210 selects the QPSK scheme, and selects the output of the QAM modulator 135 when the headend 210 selects the DSG scheme. The selected output is transmitted to the headend 210 via the diplexer 121 and input-output terminal 101.

The tuners 132, 137, demodulators 133, 138, modulators 134, 135, and selector 136 that are involved in transmitting the OOB signal constitute the OOB frontend 131 to which power is supplied by the dedicated local power supply 140.

The CPU 115 attempts to connect with the information server 204 when the digital broadcast receiver 100 is started up or when the cable card 119 is inserted. When the information server 204 is accessible and the OOB signal data are available on the network, the CPU 115 controls the local power supply 140 so that it does not supply power to the OOB frontend 131. When the information server 204 and OOB signal data are not available on the network, the CPU 115 has the local power supply 140 supply power to the OOB frontend 131 and transmits and receives OOB signals using the OOB frontend 131 as in the conventional art.

This makes it possible to perform OOB communication when the network is unavailable, without consuming unnecessary power.

In the first embodiment, the information server 204 was described as being connected to the Internet 254 and not being connected to the headend 210, but in a possible variation, the information server 204 is also connected to the cable 250 via the headend 210 and always outputs related information to the cable. At the receiving end, a digital broadcast receiver lacking a function for receiving the related information transmitted via the cable 250 does not receive the related information transmitted via the cable 250 but exchanges the related information via the Internet 254 as described in the first embodiment.

Those skilled in the art will recognize that further variations are possible within the scope of the invention, which is defined in the appended claims.

What is claimed is:

1. A data transmitting and receiving method for the transmission and reception of data related to a broadcast program via the Internet between an information server and a control unit in a digital broadcast receiver to which a conditional access card is connectable, comprising:
a step of temporarily storing the data related to the broadcast program, transmitted from the information server and received by the control unit, in a buffer in the digital broadcast receiver, while the conditional access card is connected to the digital broadcast receiver, and supplying the data related to the broadcast program to the conditional access card at a predetermined rate; and
a step in which the control unit replies to a tuning command from the conditional access card connected to the digital broadcast receiver with a pseudo confirmation response indicating the success of tuning, before transmission and reception of the data related to the broadcast program.

2. The data transmitting and receiving method of claim 1, further comprising:
a step of transmitting audio and video data of the broadcast program from a cable television station to the digital broadcast receiver via a cable; and
a step of supplying the audio and video data of the broadcast program from the digital broadcast receiver to the conditional access card;
wherein the conditional access card performs decoding for conditional access.

3. The data transmitting and receiving method of claim 2, wherein data necessary for performing the decoding for conditional access in the conditional access card are included in the data related to the broadcast program.

4. A digital broadcast receiver to which a conditional access card can be connected, comprising:
a transmitting and receiving unit configured to transmit and receive data related to a broadcast program to and from an information server via the Internet, said data related to the broadcast program including conditional access data;
a buffer in which the transmitting and receiving unit temporarily stores the data, related to the broadcast program, transmitted from the information server; and
a control unit for causing the data stored in the buffer to be supplied at a predetermined rate to the conditional access card;
wherein the transmitting and receiving unit transmits data output from the conditional access card to the information server via the Internet; and
before transmission and reception of the data related to the broadcast program, the control unit replies to a tuning command from the conditional access card with a pseudo confirmation response indicating the success of tuning.

5. The digital broadcast receiver of claim 4, further comprising:
a receiving unit configured to receive broadcast program data delivered from a cable television station via a cable;
an interface, connectable to the conditional access card for conditional access to a broadcast program received by the receiving unit, through which the broadcast program data received by the receiving unit are sent to the conditional access card while the conditional access card is connected; and
a data processing unit configured to process and output data decoded in the conditional access card.

6. The digital broadcast receiver of claim 5, wherein the data related to the broadcast program include data necessary for performing decoding for conditional access in the conditional access card.

7. The digital broadcast receiver of claim 4, wherein, when the transmitting and receiving unit cannot connect to the information server, the conditional access card is notified and does not to perform decoding for conditional access.

8. The digital broadcast receiver of claim 4, further comprising:
a frontend for transmitting and receiving the conditional access control information to and from the information server via a cable; and
a local power supply for the frontend;
wherein when the transmitting and receiving unit can receive the conditional access control data via the Internet, the control unit turns off the local power supply and controls the conditional access by using the conditional access control data received by the transmitting and receiving unit.

9. A digital broadcast receiver to which a conditional access card is connectable, comprising:
a transmitting and receiving unit configured to transmit and receive related to a broadcast program to and from an information server via the Internet, said data related to the broadcast program including conditional access data;
a buffer in which the transmitting and receiving unit temporarily stores the data related to the broadcast program transmitted from the information server;
a control unit for causing the data stored in the buffer to be supplied at a predetermined rate to the conditional access card;
a frontend for transmitting and receiving the data related to the broadcast program to and from a cable television station via a cable; and
a local power supply for the frontend;
wherein when the transmitting and receiving unit can receive the data related to the broadcast program via the Internet, the control unit turns off the local power supply and receives the broadcast program by using the data related to the broadcast program received by the transmitting and receiving unit.
